(19) United States
(12) Patent Application Publication
(10) Pub. No.: US 2011/0061029 A1
(43) Pub. Date: Mar. 10, 2011

(54) GESTURE DETECTING METHOD FOR TOUCH PANEL

(75) Inventors: Herng-Ming Yeh, Taoyuan County (TW); Yi-Ta Chen, Hsinchu City (TW)

(73) Assignee: Higgstec Inc., Taoyuan County (TW)

(21) Appl. No.: 12/875,255

(22) Filed: Sep. 3, 2010

(30) Foreign Application Priority Data
Sep. 4, 2009 (TW) 098129918

(51) Int. Cl. G06F 3/033; G06F 3/041

(52) U.S. Cl. 715/863; 345/173

(57) ABSTRACT

A gesture detecting method for a touch panel is provided. Firstly, a command mode of the touch panel is established based on a hop touch with fingers sequentially touching the touch panel. Then, a gesture is determined according to an eventually detected touch result of a single touch or multipoint touch, i.e., a detected moving track of the touch points, so as to generate and transmit a gesture instruction.

### CROSS-REFERENCES TO RELATED APPLICATIONS

This non-provisional application claims priority under 35 U.S.C. §119(a) on Patent Application No. 98129918 filed in Taiwan, R.O.C. on 2009/9/4, the entire contents of which are hereby incorporated by reference.

### BACKGROUND

1. Technical Field

The disclosure relates to a touch panel, and more particularly to a gesture detecting method for a touch panel.

2. Related Art

In the year of 2007, Apple Company released a capacitive touch phone iPhone, and made a record of selling one million sets within 74 days in the mobile phone market. This record was broken by the Apple Company's iPhone 3GS in 2009, newly released, which set a record of selling one million sets within three days. These figures demonstrate that touch panel technology has already become a success in the market.

The capacitive touch panel applied in the iPhone is a projective capacitive touch panel (PCTP), which has an electrode structure formed by a plurality of X-axis electrodes on a single layer and a plurality of Y-axis electrodes on a single layer arranged alternately, and detects the touch of an object through X-axis and Y-axis scanning. The technical requirement of multipoint touch gestures is thereby achieved, and multipoint touch can accomplish many actions which are impossible by means of single-point touch panels.

The aforementioned multipoint touch function is quite popular among consumers. However, the surface capacitive touch (SCT) panel, the technology of which is relatively mature, can only provide a single-point touch function. SCT panel is therefore inapplicable to products using multipoint touch. Furthermore, the cost structure of the SCT panel is lower than that of the PCT panel due to the configuration and manufacturing process, so that SCT panel may become highly competitive if it can provide a multipoint touch detecting function.

FIG. 1 is the basic structure of SCT panel. Electrodes N1, N2, N3, and N4 on four corners of a touch panel 1 provide different voltages, so as to form electric fields distributed uniformly on a surface of the panel. In a static state, the electric fields generated by the voltages provided to serially-connected electrodes 12, 14, 16, and 18 are distributed uniformly, in which the electric fields distributed uniformly along the X-axis and the Y-axis are sequentially formed, and a stable static capacitor is formed between an upper electrode layer and a lower electrode layer (not shown). As the electrode layer is designed with high impedance, its power consumption is rather low. When an object touches a touch point T1 on the touch panel, causing a capacitive effect, the touch panel generates a current. Based on the electric fields distributed uniformly along the X-axis and the Y-axis generated by the supplied voltages, the magnitude of the currents generated at four corners is compared by using a connector 20, so as to calculate coordinates of the touch point T1 on the X-axis and Y-axis. In the current technology, a touch motion produced by multiple points is still regarded the SCT panel as a single-point touch.

Moreover, no matter how much the numbers of points in the multipoint touch are, in the multipoint touch applications, a single gesture instruction is finally delivered. Therefore, if a single-point touch is used to simulate a multipoint touch gesture instruction, the SCT panel generally applied to single-point touch applications can be used to enable a user to output a touch gesture instruction in a multipoint manner.

In addition to the capacitive touch panel, the resistive touch panel also faces the same problem. Therefore, many touch panel manufacturers face a need to solve the problem of how to enable resistive touch panels and capacitive touch panels to convert a multipoint touch into a gesture instruction.

### SUMMARY

In order to solve the above problem in the prior art, the disclosure is directed to a multipoint touch detecting method for a touch panel which includes: determining a first touch coordinate of a first object at a first time period; determining a second touch coordinate of a second object at a second time period; calculating a first moving speed for moving from the first touch coordinate to the second touch coordinate according to a time difference between the second time period and the first time period; when the first moving speed exceeds a default value, entering a command mode; determining a moving track of the second object according to a detected current within a default time; and determining a gesture according to the moving track.

The disclosure is also directed to a multipoint touch detecting method for a capacitive touch panel, which includes: determining a plurality of touch coordinates of a plurality of objects according to a plurality of detected signal at a plurality of time periods sequentially; calculating a plurality of moving speeds of the objects using the touch coordinates; when the moving speeds exceed a default value, entering a command mode; determining a moving track of a third object according to a detected current within a default time; and determining a gesture according to the moving track.

The detailed features and advantages of the disclosure will be described in detail in the following embodiments. Those skilled in the arts can easily understand and implement the content of the disclosure. Furthermore, the relative objectives and advantages of the disclosure are apparent to those skilled in the arts with reference to the content disclosed in the specification, claims, and drawings.

### BRIEF DESCRIPTION OF THE DRAWINGS

FIG. 1 is a schematic view of touch detection of a capacitive touch panel in the prior art;

FIGS. 2A to 2I are schematic views of gesture detecting command modes and moving tracks of a touch panel according to the disclosure;

FIG. 3 is a flow chart of an embodiment of a gesture detecting method for a touch panel according to the disclosure;

FIG. 4 is a flow chart of another embodiment of a gesture detecting method for a touch panel according to the disclosure;

FIG. 5 is a flow chart of still another embodiment of a gesture detecting method for a touch panel according to the disclosure; and

FIG. 6 is a flow chart of yet another embodiment of a gesture detecting method for a touch panel according to the disclosure.

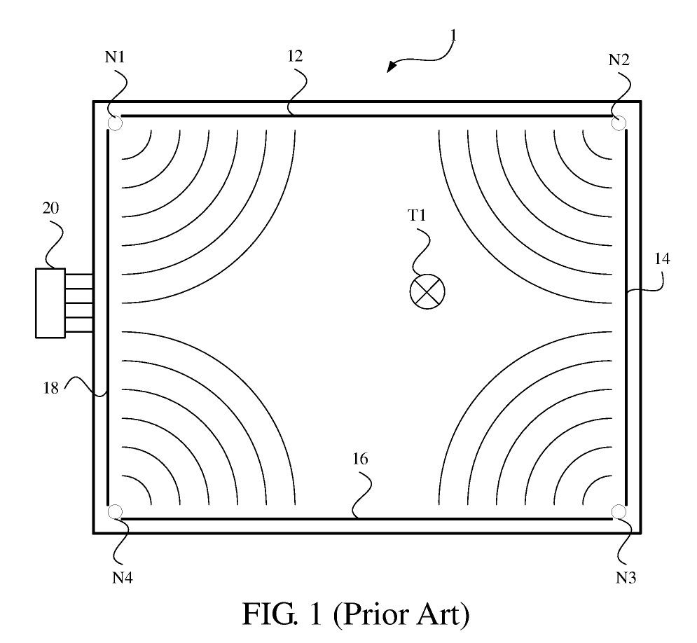

### DETAILED DESCRIPTION

The disclosure is mainly characterized by the fact that a command mode of a touch panel is established, based on a hop touch with fingers sequentially touching the touch panel. That is, when the user intends to enter the command mode and control the touch panel with several fingers, the method of the disclosure may be used to operate the touch panel to obtain a desired gesture instruction. The same method could be used for capacitive touch panel (detecting current signal) and resistive touch panel (detecting voltage signal).

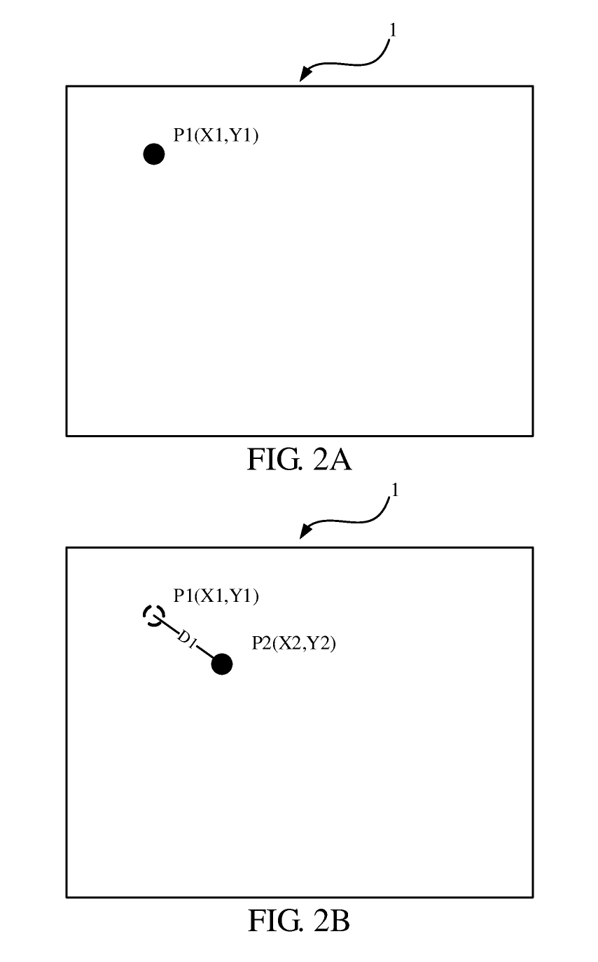

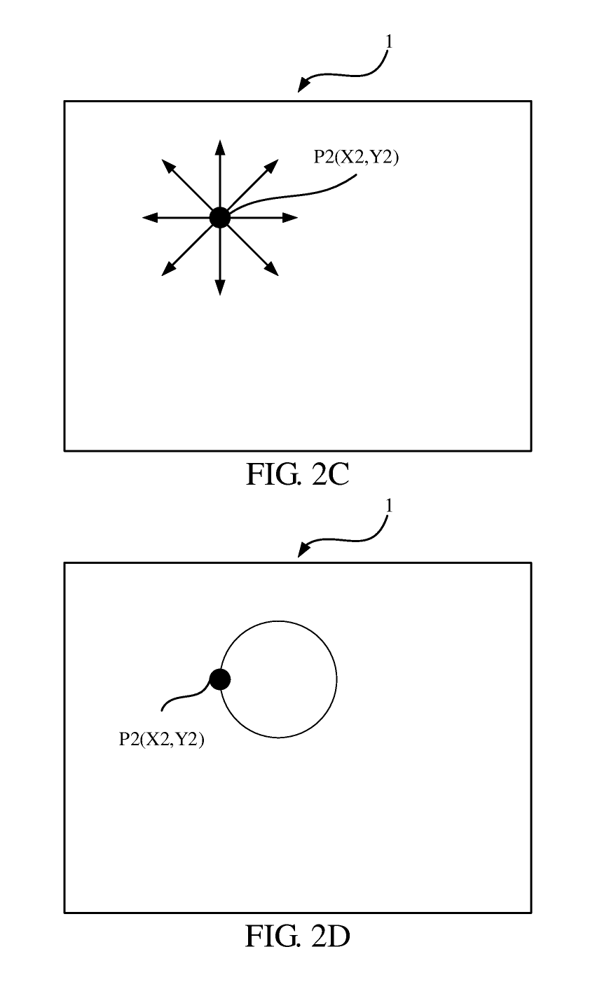

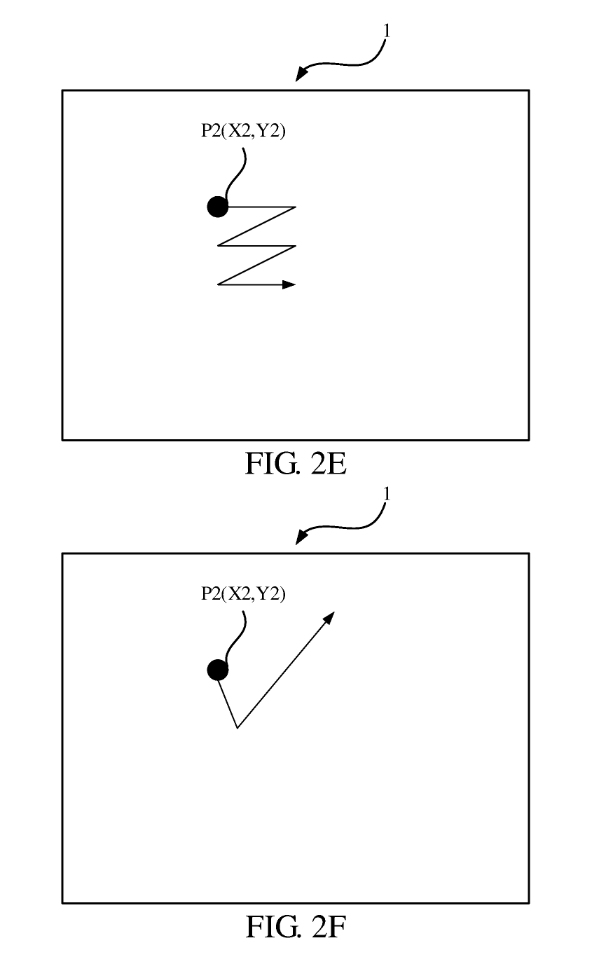

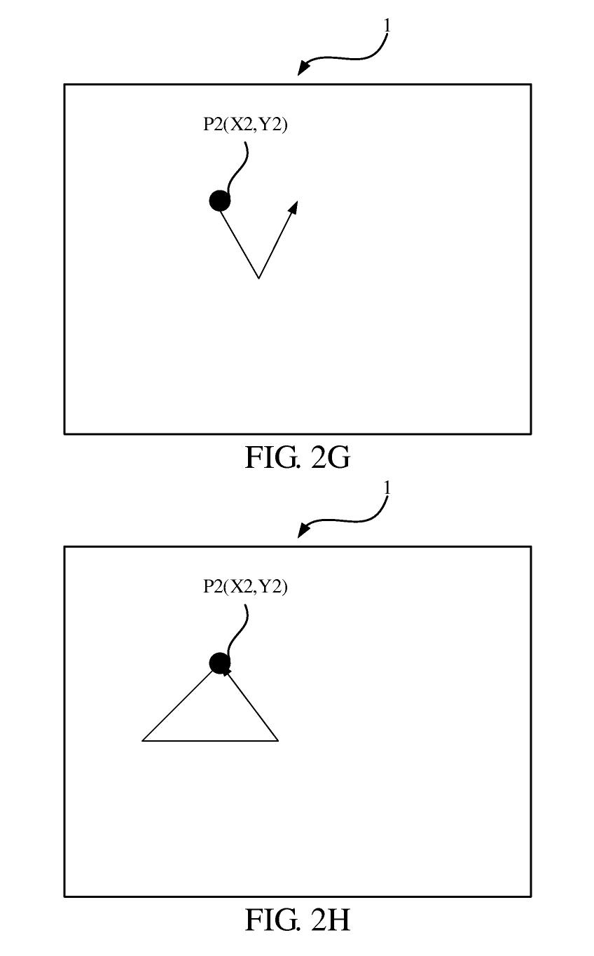

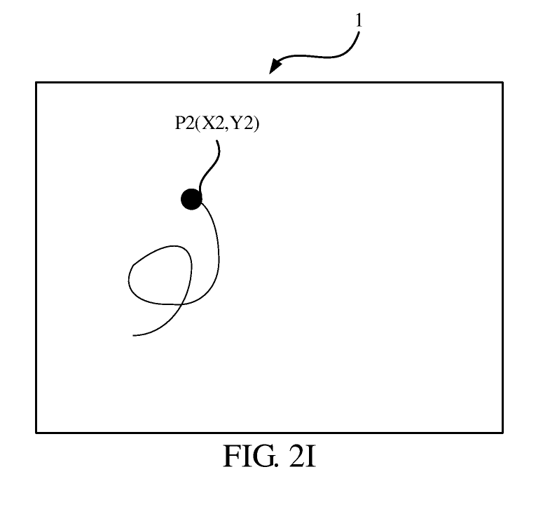

FIGS. 2A to 2H are schematic views of gesture detecting command modes and moving tracks of a capacitive touch panel according to the disclosure. FIGS. 2A and 2B are schematic views of touch points P1(X1, Y1) and P2(X2, Y2) detected by a touch panel 1. When moving from P1(X1, Y1) to P2(X2, Y2), the touch point moves for a distance of D1 at a moving speed of V1. If the moving speed V1 exceeds a default speed, i.e., the touch point detected by the touch panel hops from P1 to P2, the following two circumstances may exist: I. the hop touch is produced by touching the touch panel with a first finger and subsequently touching the touch panel with a second finger, in which the touch point detected at a second time is a midpoint of the touch point of the first finger and the touch point of the second finger; and II. The hop touch is produced by touching the touch panel with a first finger and subsequently touching the touch panel with a second finger while removing the first finger at the same time.

The disclosure may be applicable to both the above two circumstances, and the key point is that any motion for producing the hop touch is regarded as a starting point for entering the command mode in the disclosure. Certainly, instances of continuous touches with three fingers, four fingers, or five fingers may also be determined in the same manner. Although the SCT panel only detects one touch point corresponding to different continuous touches, a hop-touch result generated by the continuous touch can be used for determination, and the disclosure utilizes the part for determination as a starting point for entering the command mode.

Once entering the command mode, the system needs to recognize a “single-finger” or “multi-finger” gesture of the user, i.e., to determine a gesture according to a track after entering the “command mode”, in which the track is a final result generated by a single finger or multiple fingers at the same time, that is, an eventually-detected integrated result generated with the touch point as a single finger or multiple fingers. No matter how many fingers are used to produce the touch motion, the moving track is used for determining the gesture.

Next, please refer to FIGS. 2C to 2H, in which several examples of moving tracks are described. For example, FIG. 2C is moving tracks in upward, downward, leftward, rightward, left-upward, left-downward, right-upward, and right-downward directions, which is the moving track of the last hop-touch point detected by the touch panel 1, that is, the touch point P2(X2, Y2).

FIG. 2D is a circle-drawing moving track, which is similarly the moving track of the last hop-touch point detected by the touch panel 1, that is, the touch point P2(X2, Y2). FIG. 2E is a moving track of repeatedly moving back and forth, which is similarly the moving track of the last hop-touch point detected by the touch panel 1, that is, the touch point P2(X2, Y2). FIG. 2F is a moving track of a non-isometric checkmark, which is similarly the moving track of the last hop-touch point detected by the touch panel 1, that is, the touch point P2(X2, Y2). FIG. 2G is a moving track of an approximate isometric checkmark, which is similarly the moving track of the last hop-touch point detected by the touch panel 1, that is, the touch point P2(X2, Y2). FIG. 2H is a triangular moving track, which is similarly the moving track of the last hop-touch point detected by the touch panel 1, that is, the touch point P2(X2, Y2), and the triangle is simply an ordinary triangle. FIG. 2I shows a single-helical moving track, which is similarly the moving track of the last hop-touch point detected by the touch panel 1, that is, the touch point P2(X2, Y2).

In addition to the track examples shown in FIGS. 2C to 2I, other moving tracks may also be pre-defined and applied in the disclosure, which include: a gesture of drag up corresponding to an upward track; a gesture of dragging down corresponding to a downward track; a gesture of moving forward corresponding to a leftward track; a gesture of moving back corresponding to a rightward track; a gesture of deletion corresponding to a left-upward track; a gesture of undoing corresponding to a left-downward track; a gesture of copying corresponding to a right-upward track; a gesture of pasting corresponding to a right-downward track; a gesture of redoing corresponding to a counterclockwise rotation track; a gesture of undoing corresponding to a clockwise rotation track; a gesture of checking-off corresponding to a non-isometric checkmark track; a gesture of inserting corresponding to an isometric checkmark track; a gesture of erasing content corresponding to a back-and-forth moving track; a gesture of cutting corresponding to a single-helical track; a gesture of inserting corresponding to a triangular track; and an application specific gesture corresponding to a circle-drawing track. Other gestures may be defined independently by designers.

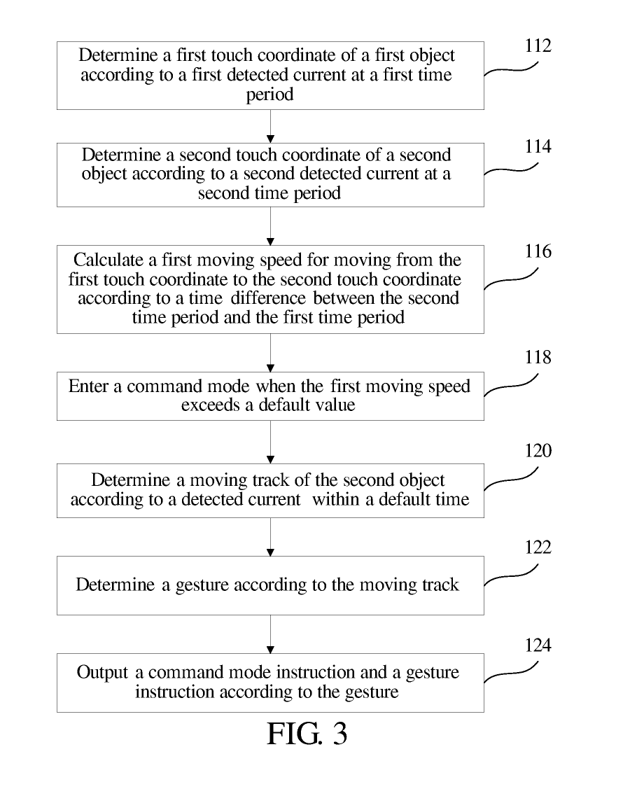

FIG. 3 is a flow chart of an embodiment of a gesture detecting method for a capacitive touch panel according to the disclosure, which includes one of the following two circumstances: I. a hop touch is produced by touching a touch panel with a first finger and subsequently touching the touch panel with a second finger, in which the touch point detected at a second time is a midpoint of the touch point of the first finger and the touch point of the second finger; and II. a hop touch is produced by touching a touch panel with a first finger and subsequently touching the touch panel with a second finger while removing the first finger at the same time. The method includes the following steps.

In Step 112, a first touch coordinate of a first object is determined according to a first detected current at a first time point, as shown in FIG. 2A.

In Step 114, a second touch coordinate of a second object is determined according to a second detected current at a second time point, as shown in FIG. 2B.

In Step 116, a first moving speed for moving from the first touch coordinate to the second touch coordinate is calculated according to a time difference between the second time point and the first time point. At this time the second finger touches the touch panel, the detected second touch coordinate is not the touch coordinate of the second finger, and calculation of the touch coordinate of the second finger is unnecessary, thereby saving the time required for calculating the coordinate.

In Step 118, when the first moving speed exceeds a default value a command mode is entered. If the first moving speed exceeds the default value it indicates that the fingers perform a hop motion, that is, the aforementioned circumstances of the disclosure, so that the hop motion can be determined, thereby entering the command mode.

In Step 120, a moving track of the second object is determined according to a detected current within a default time. In the actual movement, the touch point detected by the touch panel moves in a continuous moving track.

In Step 122, a gesture is determined according to the moving track. The continuous moving track is compared with default moving tracks in a database, so as to determine the gesture. The comparison may be made using trend analysis or fuzzy matching.

In Step 124, a gesture instruction is output according to the gesture.

In Step 124, a coordinate of the second object may also be output, or a command mode instruction may be output, or both the coordinate of the second object and the command mode instruction may be output, so as to provide diversified information for selection by a command receiver.

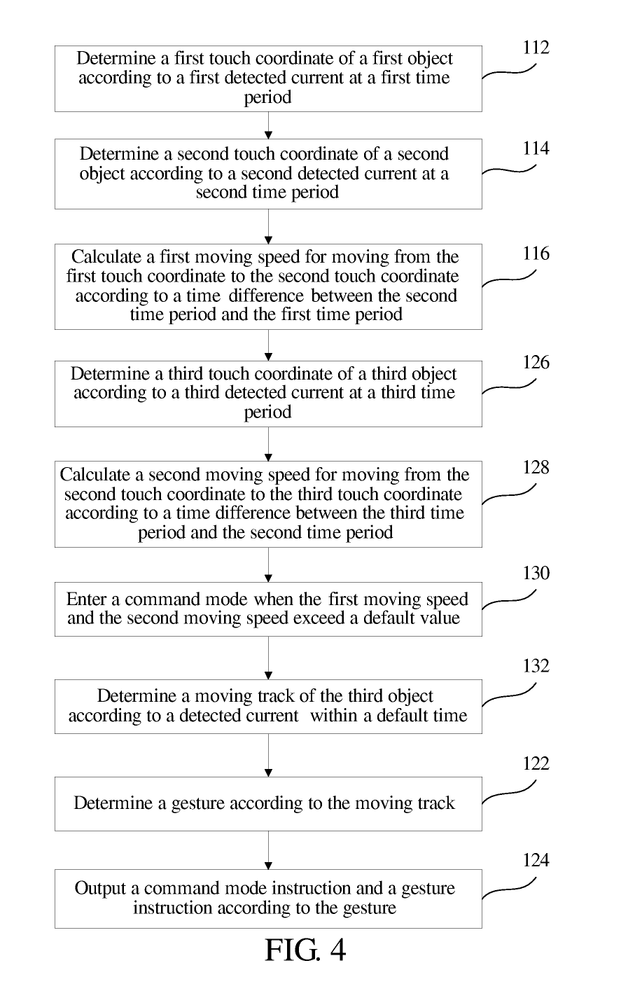

FIG. 4 is a flow chart of another embodiment of a gesture detecting method for a capacitive touch panel according to the disclosure, in which three fingers touch the touch panel consecutively. The method of this embodiment includes the following steps.

In Step 112, a first touch coordinate of a first object is determined according to a first detected current at a first time point, as shown in FIG. 2A.

In Step 114, a second touch coordinate of a second object is determined according to a second detected current at a second time point. At this time the second finger touches the touch panel, the detected second touch coordinate is not the touch coordinate of the second finger, and calculation of the touch coordinate of the second finger is unnecessary, thereby saving the time required for calculating the coordinate.

In Step 116, a first moving speed for moving from the first touch coordinate to the second touch coordinate is calculated according to a time difference between the second time point and the first time point, as shown in FIG. 2B.

In Step 126, a third touch coordinate of a third object is determined according to a third detected current at a third time point. At this time, the third finger touches the touch panel, the detected third touch coordinate is not the touch coordinate of the third finger, and calculation of the touch coordinate of the touch coordinate of the third finger is unnecessary, thereby saving the time required for calculating the coordinate.

In Step 128, a second moving speed for moving from the second touch coordinate to the third touch coordinate is calculated according to a time difference between the third time point and the second time point.

In Step 130, when the first moving speed and the second moving speed exceed a default value, a command mode is entered. If the first moving speed and the second moving speed exceed the default value, it indicates that both the two cases are hop motions, that is, the aforementioned circumstances of the disclosure, so that the hop motion can be determined, thereby entering the command mode.

In Step 132, a moving track of the third object is determined according to a detected current within a default time. In the actual movement, the touch point detected by the touch panel moves in a continuous moving track.

In Step 122, a gesture is determined according to the moving track. The continuous moving track is compared with default moving tracks in a database, so as to determine the gesture. The comparison may be made using trend analysis or fuzzy matching.

In Step 124, a gesture instruction is output according to the gesture.

In Step 124, a coordinate of the second object may also be output, or a command mode instruction may be output, or both the coordinate of the second object and the command mode instruction may be output, so as to provide diversified information for selection by a command receiver.

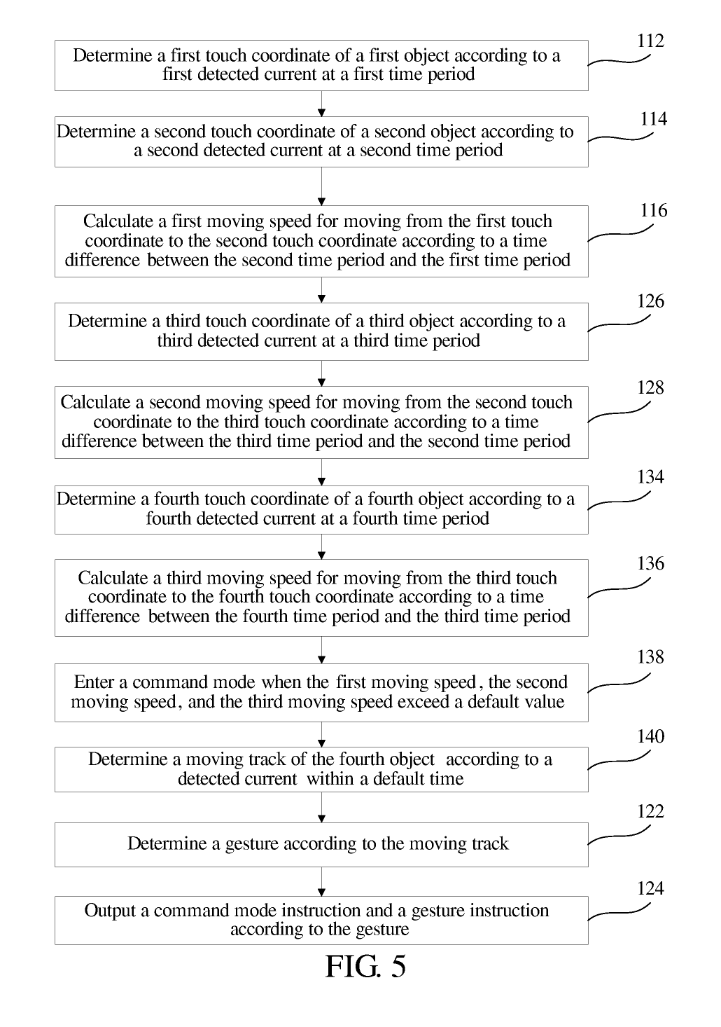

FIG. 5 is a flow chart of still another embodiment of a gesture detecting method for a capacitive touch panel according to the disclosure, in which four fingers touch the touch panel consecutively. The method of this embodiment includes the following steps.

In Step 112, a first touch coordinate of a first object is determined according to a first detected current at a first time point, as shown in FIG. 2A.

In Step 114, a second touch coordinate of a second object is determined according to a second detected current at a second time point. At this time, the second finger touches the touch panel, the detected second touch coordinate is not the touch coordinate of the second finger, and calculation of the touch coordinate of the second finger is unnecessary, thereby saving the time required for calculating the coordinate.

In Step 116, a first moving speed for moving from the first touch coordinate to the second touch coordinate is calculated according to a time difference between the second time point and the first time point, as shown in FIG. 2B.

In Step 126, a third touch coordinate of a third object is determined according to a third detected current at a third time point. At this time, the third finger touches the touch panel, the detected third touch coordinate is not the touch coordinate of the third finger, and calculation of the touch coordinate of the third finger is unnecessary, thereby saving the time required for calculating the coordinate.

In Step 128, a second moving speed for moving from the second touch coordinate to the third touch coordinate is calculated according to a time difference between the third time point and the second time point.

In Step 134, a fourth touch coordinate of a fourth object is determined according to a fourth detected current at a fourth time point. At this time, the fourth finger touches the touch panel, the detected fourth touch coordinate is not the touch coordinate of the fourth finger, and calculation of the touch coordinate of the fourth finger is unnecessary, thereby saving the time required for calculating the coordinate.

In Step 136, a third moving speed for moving from the third touch coordinate to the fourth touch coordinate is calculated according to a time difference between the fourth time point and the third time point.

In Step 138, when the first moving speed, the second moving speed, and the third moving speed exceed a default value, a command mode is entered. If the first moving speed, the second moving speed, and the third moving speed exceed the default value, it indicates that the three cases are hop motions, that is, the aforementioned circumstances of the disclosure, so that the hop motion can be determined, thereby entering the command mode.

In Step 140, a moving track of the fourth object is determined according to a detected current within a default time. In the actual movement, the touch point detected by the touch panel moves in a continuous moving track.

In Step 122, a gesture is determined according to the moving track. The continuous moving track is compared with default moving tracks in a database, so as to determine the gesture. The comparison may be made using trend analysis or fuzzy matching.

In Step 124, a gesture instruction is output according to the gesture.

In Step 124, a coordinate of the second object may also be output, or a command mode instruction may be output, or both the coordinate of the second object and the command mode instruction may be output, so as to provide diversified information for selection by a command receiver.

As seen from the embodiments shown in FIGS. 3 to 5, the method of the disclosure is applicable to multi-finger touches, and used for simulating a multi-finger touch motion along a multipoint touch moving track, thereby generating a method for determining an output result of a multipoint touch gesture.

A capacitive touch panel is taken as an example in the above mentioned drawings. The method of the disclosure is also applicable to a resistive touch panel. The differences between the resistive touch panel and the capacitive touch panel lie in the structure of the touch panel and the method for detecting the coordinate of the touch point. Here, the coordinate of the touch point is detected in a manner of detecting the voltage variation.

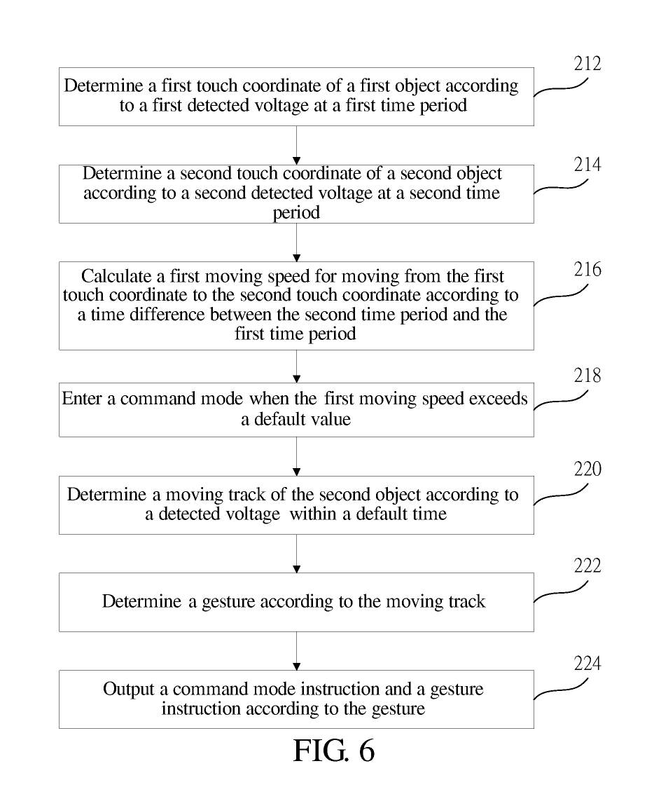

FIG. 6 is a flow chart of a gesture detecting method for a resistive touch panel according to the disclosure. As seen from FIGS. 3 and 6, the difference between the two embodiments is that the embodiment in FIG. 3 obtains the coordinate of the touch point in a current detecting manner, whereas the embodiment in FIG. 6 obtains the coordinate of the touch point in a voltage detecting manner. Therefore, the two embodiments adopt different detecting manners depending upon different structures of the two touch panels. The method of this embodiment includes the following steps.

In Step 212, a first touch coordinate of a first object is determined according to a first detected voltage at a first time point, as shown in FIG. 2A.

In Step 214, a second touch coordinate of a second object is determined according to a second detected voltage at a second time point, as shown in FIG. 2B.

In Step 216, a first moving speed for moving from the first touch coordinate to the second touch coordinate is calculated according to a time difference between the second time point and the first time point. At this time, the second finger touches the touch panel, the detected second touch coordinate is not the touch coordinate of the second finger, calculation of the touch coordinate of the second finger is unnecessary, thereby saving the time required for calculating the coordinate.

In Step 218, when the first moving speed exceeds a default value a command mode is entered. If the first moving speed exceeds the default value, it indicates that the fingers perform a hop motion, that is, the aforementioned circumstance of the disclosure, so that the hop motion can be determined, thereby entering the command mode.

In Step 220, a moving track of the second object is determined according to a detected voltage within a default time. In the actual movement, the touch point detected by the touch panel moves in a continuous moving track.

In Step 222, a gesture is determined according to the moving track. The continuous moving track is compared with default moving tracks in a database, so as to determine the gesture. The comparison may be made by using trend analysis or fuzzy matching manner.

In Step 224, a gesture instruction is output according to the gesture.

In Step 224, a coordinate of the second object may also be output, or a command mode instruction may be output, or both the coordinate of the second object and the command mode instruction may be output, so as to provide diversified information for selection by a command receiver.

The method of the embodiments in FIGS. 4 and 5 may also be applied to a resistive touch panel. The difference between the method applied to a capacitive touch panel and the method applied to a resistive touch panel is that, the current detecting manner needs to be altered into the voltage detecting manner when being applied to the resistive touch panel. The rest of the two methods are the same, which will not be described herein again.

While the disclosure has been described by the way of example and in terms of the preferred embodiments, it is to be understood that the invention need not to be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A gesture detecting method for a touch panel, comprising:
determining a first touch coordinate of a first object at a first time period;
determining a second touch coordinate of a second object at a second time period;
calculating a first moving speed for moving from the first touch coordinate to the second touch coordinate according to a time difference between the second time period and the first time period;
entering a command mode, when the first moving speed exceeds a default value;
determining a moving track of the second object within a default time period; and
determining a gesture according to the moving track.

2. The method according to claim 1, further comprising: outputting a gesture instruction according to the gesture.

3. The method according to claim 1, further comprising: outputting a command mode instruction.

4. The method according to claim 2, further comprising: outputting a coordinate of the first object.

5. The method according to claim 4, further comprising: outputting a coordinate of the second object.

6. The method according to claim 1, wherein the step of determining the gesture according to the moving track further comprises the step of: comparing the moving track with a plurality of default moving tracks stored in a database, so as to determine the gesture.

7. The method according to claim 1, wherein the moving track is selected from a group consisting of: an upward track, a downward track, a leftward track, a rightward track, a left-upward track, a left-downward track, a right-upward track, a right-downward track, a counterclockwise rotation track, a clockwise rotation track, a non-isometric checkmark track, an isometric checkmark track, a triangular track, a back-and-forth moving track, a single-helical track, and a circle-drawing track.

8. The method according to claim 7, wherein the gesture is selected from a group consisting of:
a gesture of dragging up corresponding to the upward track;
a gesture of dragging down corresponding to the downward track;
a gesture of moving forward corresponding to the leftward track;
a gesture of moving back corresponding to the rightward track;
a gesture of deleting corresponding to the left-upward track;
a gesture of undoing corresponding to the left-downward track;
a gesture of copying corresponding to the right-upward track;
a gesture of pasting corresponding to the right-downward track;
a gesture of redoing corresponding to the counterclockwise rotation track;
a gesture of undoing corresponding to the clockwise rotation track;
a gesture of checking-off corresponding to the non-isometric checkmark track;
a gesture of inserting corresponding to the isometric checkmark track;
a gesture of inserting corresponding to the triangular track;
a gesture of erasing content corresponding to the back-and-forth moving track;
a gesture of cutting corresponding to the single-helical track; and
an application specific gesture corresponding to the circle-drawing track.

9. The method according to claim 1, wherein the steps of determining the first touch coordinate and the second touch coordinate are performed according to detected currents.

10. The method according to claim 1, wherein the steps of determining the first touch coordinate and the second touch coordinate are performed according to detected voltages.

11. A gesture detecting method for a touch panel, comprising:
determining a plurality of touch coordinates of a plurality of objects at a plurality of time periods sequentially;
calculating a plurality of moving speeds of the objects using the touch coordinates;
entering a command mode, when the moving speeds exceed a default value;
determining a moving track of a third object according to a detected signal within a default time; and
determining a gesture according to the moving track.

12. The method according to claim 11, further comprising: outputting a gesture instruction according to the gesture.

13. The method according to claim 11, further comprising: outputting a command mode instruction.

14. The method according to claim 12, further comprising: outputting a coordinate of a first object.

15. The method according to claim 14, further comprising: outputting a coordinate of a second object.

16. The method according to claim 11, wherein the step of determining the gesture according to the moving track further comprises the step of: comparing the moving track with a plurality of default moving tracks stored in a database, so as to determine the gesture.

17. The method according to claim 11, wherein the moving track is selected from a group consisting of: an upward track, a downward track, a leftward track, a rightward track, a left-upward track, a left-downward track, a right-upward track, a right-downward track, a counterclockwise rotation track, a clockwise rotation track, a non-isometric checkmark track, an isometric checkmark track, a triangular track, a back-and-forth moving track, a single-helical track, and a circle-drawing track.

18. The method according to claim 17, wherein gesture is selected from a group consisting of:
a gesture of dragging up corresponding to the upward track;
a gesture of dragging down corresponding to the downward track;
a gesture of moving forward corresponding to the leftward track;
a gesture of moving back corresponding to the rightward track;
a gesture of deleting corresponding to the left-upward track;
a gesture of undoing corresponding to the left-downward track;
a gesture of copying corresponding to the right-upward track;
a gesture of pasting corresponding to the right-downward track;
a gesture of redoing corresponding to the counterclockwise rotation track;
a gesture of undoing corresponding to the clockwise rotation track;
a gesture of checking-off corresponding to the non-isometric checkmark track;
a gesture of inserting corresponding to the isometric checkmark track;
a gesture of inserting corresponding to the triangular track;
a gesture of erasing content corresponding to the back-and-forth moving track;
a gesture of cutting corresponding to the single-helical track; and
an application specific gesture corresponding to the circle-drawing track.

19. The method according to claim 11, wherein the detected signal is current.

20. The method according to claim 11, wherein the detected signal is voltage.
